(19) United States
(12) Patent Application Publication
(10) Pub. No.: US 2006/0050698 A1
(43) Pub. Date: Mar. 9, 2006

(54) Methods and systems using signaling period signals

(75) Inventors: Turgut Aytur, Plattsburgh, NY (US); Ravishankar H. Mahadevappa, Irvine, CA (US); Venkatesh Rajendran, Irvine, CA (US); Stephan ten Brink, Irvine, CA (US); Ran Yan, Holmdel, NJ (US)

Correspondence Address: CHRISTIE, PARKER & HALE, LLP, PO BOX 7068, PASADENA, CA, 91109-7068, US

(73) Assignee: Orion Microelectronics Corporation

(21) Appl. No.: 11/205,337

(22) Filed: Aug. 16, 2005

Related U.S. Application Data
(60) Provisional application No. 60/601,834, filed on Aug. 16, 2004.

(51) Int. Cl. H04L 12/56

(52) U.S. Cl. 370/389; 370/252

(57) ABSTRACT

Methods and systems using information derived during a signaling period of a scheduling-based Medium Access Control protocol to adjust operation effective during data transmission periods. For example, channel estimation and transmission power adjustments are made based on indications provided by received signals.

### CROSS-REFERENCE TO RELATED APPLICATIONS

This application claims the benefit of U.S. Provisional Application No. 60/601,834 filed Aug. 16, 2004, the disclosure of which is incorporated herein.

### BACKGROUND OF THE INVENTION

The present invention relates generally to scheduling-based wireless communication and more particularly to use of received signaling information for data transmission adjustments.

Many Medium Access Control (MAC) protocols have been designed to provide fair share of the wireless medium with adequate throughput and delay performance in wireless networks. MAC protocols can be broadly classified into either contention-based or scheduling-based protocols depending on the channel access mechanism. In a contention-based MAC protocol, devices contend for channel access whenever they have a packet to send. An example of a contention-based MAC protocol is a Carrier Sense Multiple Access (CSMA) protocol, and variations thereof, in which a devices largely transmits after sensing whether another device is currently transmitting. Wireless Local Area Networks (WLAN) have typically used contention-based MAC protocols, such as IEEE 802.11 Distributed Coordination Function (DCF). Throughput of the contention-based protocols are generally good as long as the network is operated under low load. However, with increasing demand for multimedia applications in consumer wireless networks and increases in physical layer data rates, channel utilization and throughput offered by contention-based protocols may be inadequate. This can be attributed, in part, to the fixed overhead associated with channel access because of inter-frame separations, and back-off mechanisms.

Scheduling-based MAC protocols establish transmission schedules such that transmissions are non-interfering. The transmission schedules may allocate different time slots, different frequency channels, or different spreading codes to different transmitters to avoid interference. Transmission schedules may be assigned by a centralized controller or may be established in a distributed fashion. For example, in a cellular communication network a base station may act as a centralized scheduler and allocate different transmission schedules to mobile nodes. An example transmission schedule uses Time-Division Multiple Access (TDMA), with time divided into slots and devices allocated different time slots for non-interfering transmission. A centralized coordinator of the base station allocates different slots within a super-frame to different devices based on requests from the devices. With a scheduling-based MAC protocol higher channel utilization could be achieved. However, having a centralized scheduler is not optimal for all network applications. For example, in a wireless personal area network wireless devices typically organize themselves as an ad hoc network without a centralized controller. A number of distributed scheduling-based MAC protocols have been proposed for such ad hoc wireless networks, including some with super-frame structures. An example scheme may be found, for example, in U.S. Pat. No. 5,682,382, incorporated by reference herein.

To adapt transmission schedules to traffic characteristics, topology changes and device capabilities, TDMA slots may be divided into signaling and data transmission slots. Transmissions are scheduled during a data slot period using the information gathered during a signaling period. During the signaling period (also called a beacon period), each active device reinforces the timing of the network, and can make reservations for slots that follow the signaling period. Signaling packets (also called as beacons) can include existing channel reservations in the super-frame. However, even using scheduling schemes, for example TDMA scheduling schemes, may not fully utilize available bandwidth or make use of transmitted information.

For example, channel estimation is normally performed for a fixed period during the preamble of a data packet. Due to noise, the finite estimation time, and other factors, the channel estimation process is lossy. In most systems, the channel estimation sequence is a fixed length during the preamble.

Another set of parameters which generally is determined is the RF front-end gain settings, often determined through an Automatic Gain Control (AGC) process. In an ad hoc wireless network the wireless devices are distributed in an arbitrary manner, i.e., the distance between two communicating devices is not fixed. As a result the signals transmitted from two different devices may have different signal strengths when they reach the intended receiver. At the receiver some variable-gain amplifiers are set to suitable gain values so that the signal delivered to the next stage lies in a certain desirable range. The settings used for these amplifiers are usually modified for each data packet received.

Power control algorithms are common in cellular communication networks and are an effective way to increase overall network capacity. In a network with centralized control, the controller can mandate power transmission regulation through control loops. These systems typically involve the controller measuring upstream power and reporting during downstream transmission. The clients adjust their power to meet the target. In an ad hoc network without a centralized controller, this scheme is not possible.

A wireless communications environment may be comprised of many networks operating simultaneously. Some networks may use different frequencies to avoid interference. However, it is possible that some interference be present from sources other than the intended transmitter.

Data communication systems may support multiple data transmission rates. These data rates typically have different minimum SNR or other link parameter requirements. Higher data rates typically require higher SNR. The selection of appropriate transmission rate may be influenced by other constraints, such as application requirements. However, it is common that an application may request the highest available rate from a data link. Wireless data links may rely on rate adaptation algorithms to help find the highest available rate. Typically, this is an iterative process that involves trying a higher rate and lowering it after unsuccessful transmission.

### SUMMARY OF THE INVENTION

This invention describes methods and systems for improving wireless air interface performance when a distributed scheduling-based MAC protocol with signaling or beacon periods is used. These methods and systems are particularly applicable to wireless networks. Distributed scheduling-based MAC protocols generally have active devices exchange specific information during the signaling or beacon period. Therefore, each frame will ordinarily contain some known information from each device. By receiving this information periodically through the wireless air interface, useful information about the wireless interface itself can be determined and used.

In various aspects, the invention provides a method of adjusting operation of a wireless communication device operating in a scheduling-based transmission network, comprising receiving a signal from another device during a scheduling period; determining an aspect of the received signal; and adjusting operation of the device during a data transmission period based on the aspect of the received signal.

In other various aspects the invention provides a method for use by a wireless communication device to initialize channel estimates for data transmission periods in networks using scheduling-based access protocols; comprising receiving a signal during a beacon period from another device; estimating a channel quality of a communication channel between the other device and the wireless communication device using the signal received during the beacon period; storing an indication of the estimate of the channel quality of the communication channel between the other device and the wireless communication device; receiving a preamble signal during a data transmission period from the other device; processing the preamble signal using the indication of the estimate of channel quality of the communication channel between the other device and the wireless communication device.

In other various aspects the invention provides a method for use by a wireless communication device to determine a transmission rate for data transmitted by the wireless communication device, comprising receiving a signal during a signaling period from another device; estimating a channel quality of a communication channel between the other device and the wireless communication device using the signal received during the signaling period; determining a transmission rate for data transmission from the wireless communication device to the other device during a data transmission period using the estimate of channel quality.

This and other aspects of the invention are more fully comprehended on review of this disclosure including the accompanying figures.

### BRIEF DESCRIPTION OF THE DRAWINGS

FIG. 1 is a block diagram of a receiver in accordance with aspects of the invention;

FIG. 2 shows a typical packet structure in accordance with aspects of the invention;

FIG. 3 shows a TDMA super-frame structure in accordance with aspects of the invention;

FIG. 4 is a flow diagram of a process for channel estimation in accordance with aspects of the invention;

FIG. 5 shows two transmitter groups and an indication of transmission power;

FIG. 6 is a block diagram of a further receiver in accordance with aspects of the invention;

FIG. 7 is a flow diagram of a process for transmission power adjustment in accordance with aspects of the invention; and

FIG. 8 is a flow diagram of a process for reducing interference in accordance with aspects of the invention.

### DETAILED DESCRIPTION

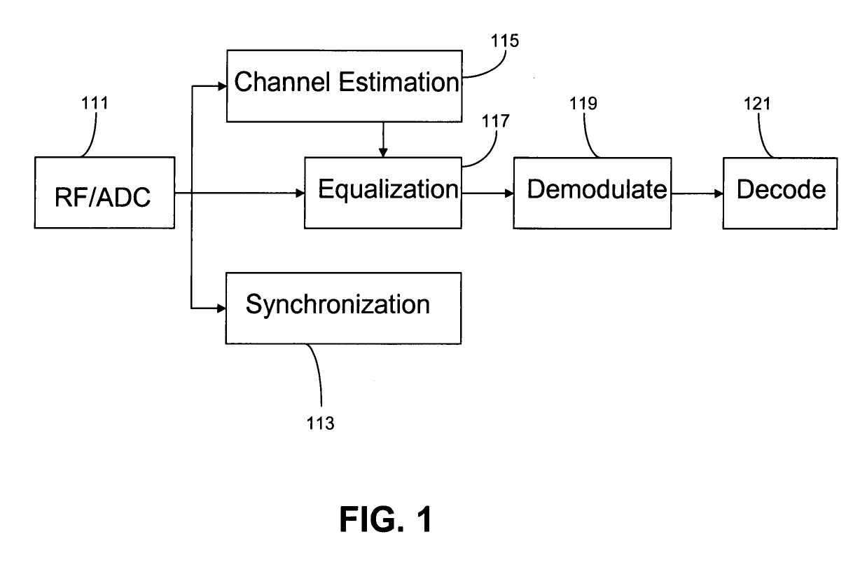

A simplified diagram of a typical digital communications receiver is shown in FIG. 1. The receiver includes radio frequency (RF) processing circuits 111, which as shown include an analog-to-digital connector (ADC) for digitizing received signals. The RF processing circuits are sometimes referred to as an analog RF front-end for a receiver. The digitized signals are provided to a synchronization block 113, primarily for packet detection, timing, and framing purposes. The digitized signals are also provided to a channel estimation block 115, which performs channel estimation.

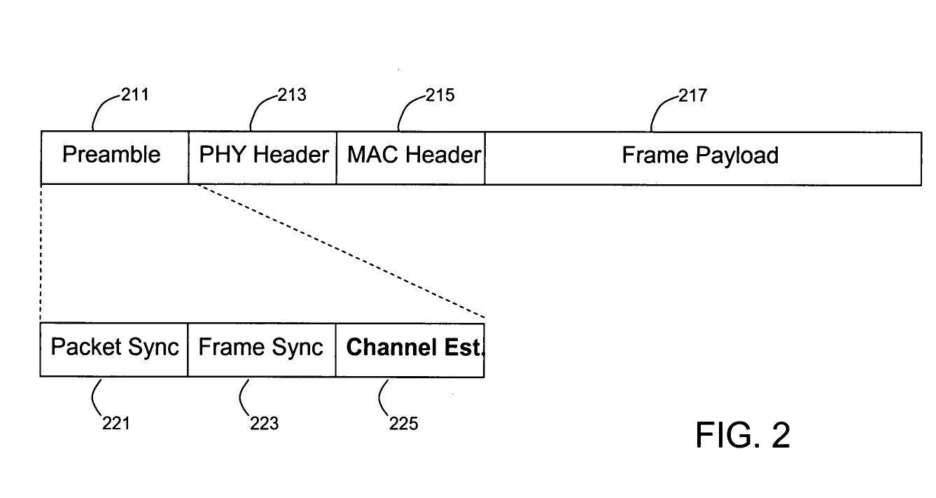

In many embodiments the channel estimation block estimates channel quality using channel estimation symbols present in a preamble of a packet. FIG. 2 shows a packet format for a typical wireless data packet. The packet includes a preamble 211, a PHY header 213, a MAC header 213, and a frame payload 217. The preamble includes a packet synchronization sequence 221, a frame synchronization sequence 223, and channel estimation symbols 225. The packet and frame synchronization sequences are generally known predefined sequences, as are the channel estimation symbols. The channel estimation symbols are used to perform channel estimation. In some embodiments, and as discussed below, the channel estimation block estimates channel quality for data period transmissions using signaling period information.

Returning to FIG. 1, an equalization block 117 receives the digitized signals and processes the signals in accordance with signals from the channel estimation block. The processed signals are demodulated and decoded by a demodulate block 119 and a decode block 121, respectively, which also may use processes dependent on channel estimation information.

The channel estimation circuitry attempts to solve:
y=hx+n (1)

Where x represents the transmitted symbols, h represents the wireless channel, n is noise, and y is the received signal. By comparing the known information transmitted during the training sequence with the received signal, h can estimated.

In some embodiments with a beacon-based access scheme the channel estimation block provides an initial estimate of the channel during the beacon period. The initial estimate is, in various embodiments, used to improve channel estimation during the data packet reception, or to provide algorithmic input to the receiver demodulation and decoding process.

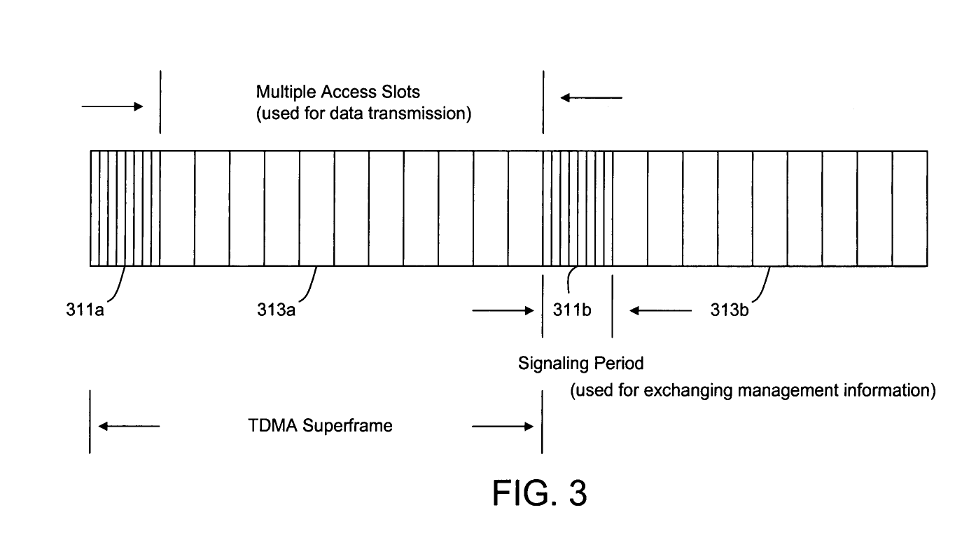

FIG. 3 shows a TDMA super-frame structure with signaling periods 311a,b and data transmission periods 315a,b. In time slots of the signaling period devices transmit indications regarding transmission of data in time slots of a subsequent data transmission period. The transmissions during the signaling period include known symbols. The signaling periods are each comprised of a plurality of time slots, as are the data transmission periods, with the time slots of the data transmission period sometimes referred to as data access slots or multiple access slots.

The beacon period provides additional input for the channel estimation process. During the beacon period, the device, such as the device of FIG. 1, determines and stores channel estimates for one member, or multiple members, of a beacon group. When a packet from a particular beacon-group member is sent during the data access slots, the device uses the channel estimates, such as by using the stored channel parameters as an initial channel estimate, or may use these parameters as an input to improve the channel estimate.

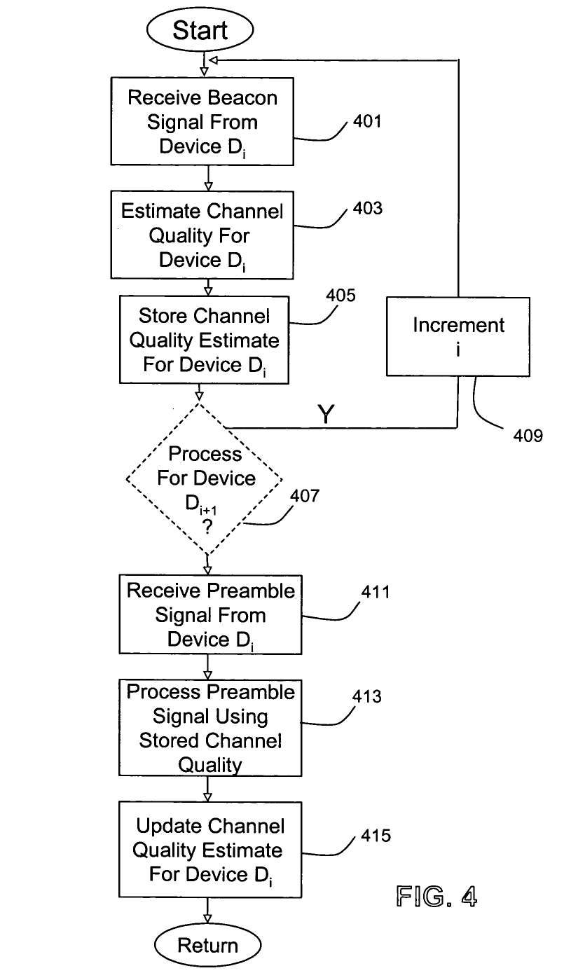

FIG. 4 illustrates a flow diagram of an embodiment of a process for using signaling period signals for channel quality estimation. In block 401 a device receives a beacon signal from another device Dᵢ. In block 403 a process, for example configured in hardware or executing as a software program on the device, estimates the channel quality using the signal received from device Dᵢ. In some embodiments channel quality estimation is performed as is done for channel quality estimation during processing of a preamble of a data packet, as such is known to one of ordinary skill or a person skilled in the art. In block 405 a process stores an indication of the channel quality for device Dᵢ. In some embodiments the indication of channel quality is stored in RAM of the device.

In some environments, multiple devices may be part of what may be considered an ad hoc network. Accordingly, in some embodiments of the process, optionally in block 407 the device evaluates whether to process channel quality estimates for further other devices. Thus, in optional block 407 the process determines whether to continue processing for further devices, such as device Dᵢ₊₁. If so, in block 409 the process increments i and continues to block 401.

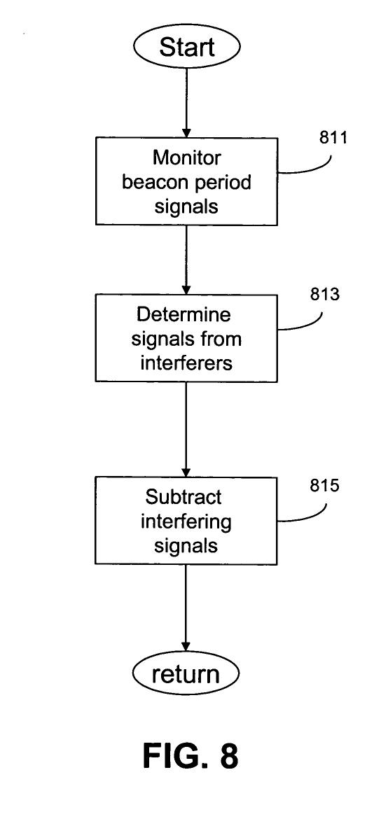

In block 411 the process, or device executing the process, receives a preamble signal from device Dᵢ. In block 413 the process processes the preamble signal from Dᵢ. In processing the preamble signal from Dᵢ, the process uses a stored indication of channel quality as part of processing, or operating on, the preamble signal. This may, for example, allow for improvement of data recovery of the received preamble signal. In addition, in the embodiment of the process illustrated in FIG. 8, the processing of the preamble signal includes further channel estimation. In block 415 the process updates the channel estimate for device Dᵢ. The process thereafter returns.

In a distributed scheduling-based MAC protocol, since the transmitter transmits a beacon packet declaring its intentions to transmit data later in the super-frame, the gain settings determined while detecting the beacon also may be stored at the receiver and reused to improve performance in detecting data packets in the data transmission period.

Signaling period signals may be used by a receiver to set automatic gain control settings, such as gains associated with low noise amplifiers, mixers, and variable gain amplifiers of the RF analog front-end. In some embodiments the AGC settings determined during a signaling period are also used during a subsequent, particularly an immediately subsequent, data transmission period. In some of these embodiments the same AGC settings are used in the data transmission periods as determined in the signaling periods. In some embodiments the AGC settings determined during the signaling period are used as initial settings in the data transmission period, thereby expected to reduce settling times.

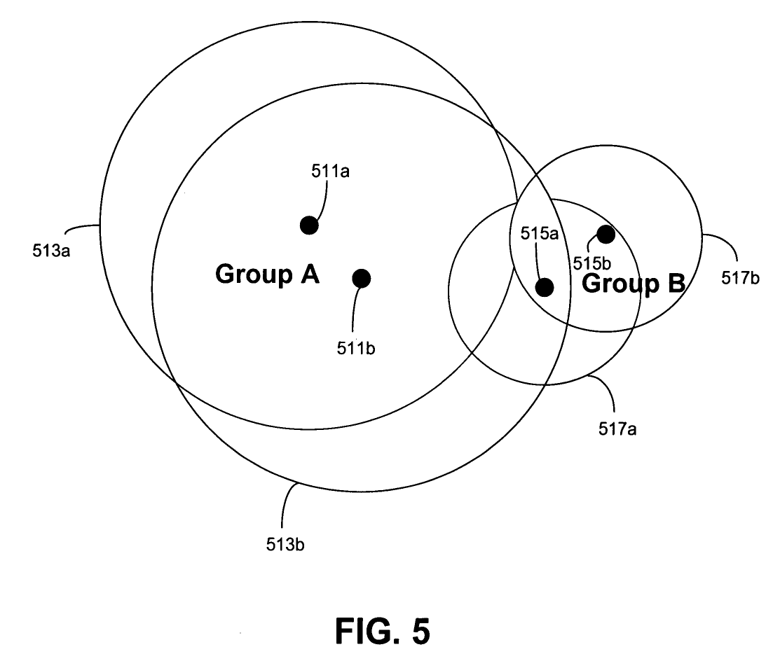

FIG. 5 shows two groups of radio transmitters with different transmit power levels. A device 511 a and a device 513b are in a Group A. The devices in Group A transmit at a first power level. As transmit power levels increase, transmission range also tends to increase. Accordingly, circles 513a,b associated with devices 511a,b are relatively large, indicating relatively large transmission distances. As the transmission distances are significantly greater than the distance separating devices 511a,b, Group A shows devices that are transmitting with power levels that are higher than required for reliable transmission. FIG. 5 also shows devices 515a,b, part of a Group B. Circles 517a,b indicate transmission distances for devices 515a,b which are appropriate for transmission between the two devices. Accordingly, the devices of Group B are transmitting with power levels required for reliable transmission. However, Group A is interfering with some nodes in Group B. If Group A transmission power is reduced, both networks can operate with reduced interference.

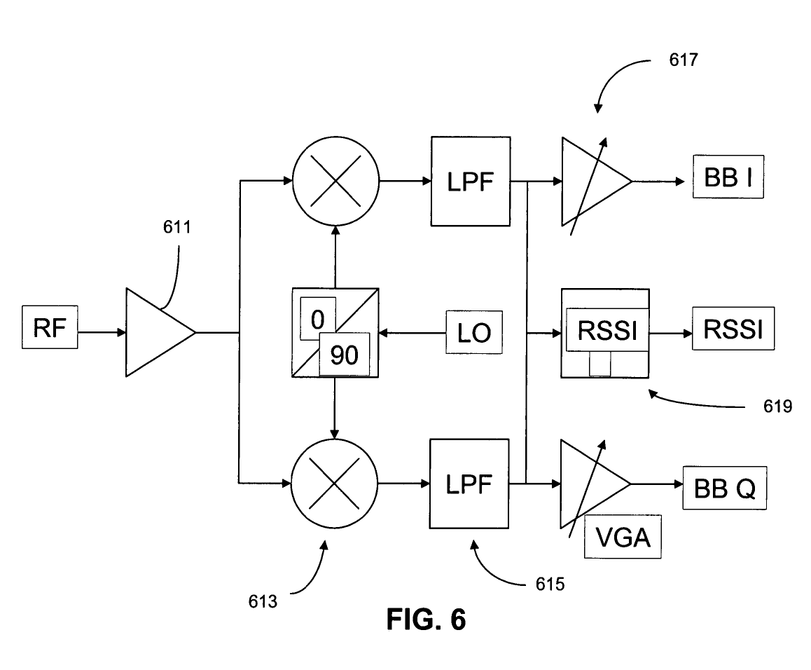

During the beacon period, in some embodiments beacon transmissions are at known (predetermined) power levels, and in some embodiments the beacon transmissions include an indication of transmission power as part of the transmission. FIG. 6 shows a simplified diagram of a typical analog receiver for digital wireless communications. The receiver includes Radio Frequency (RF) amplifiers 611 in phase and quadrature frequency translation circuitry 613, filters 615, Variable-Gain Amplifiers (VGA) 617, and Receive Strength Signal Indication (RSSI) circuitry 619. RSSI is commonly employed in Automatic Gain Control (AGC) loops, and in some embodiments provides an estimation of the power level of a received signal. In other embodiments the VGA settings are monitored to indirectly determine the received power. Once the received power is estimated, the path loss between two members in the beacon group may determined by subtracting the received power level (in dBm), for example, from the known transmit power level from the beacon period. Thus, by learning the path loss between users in a beacon group, a beacon member can adjust the transmit power level during a data packet in a manner that ensures reliable transmission of information but reduces the level of interference to other beacon groups. For example, in some embodiments a device determines transmission power of a received signal from another device during a signaling, or beacon, period. The device stores an indication of the transmission power, or an estimate of path loss, based on an indication received signal strength and the indication of transmission power. Then, when the device transmits information to the other device, the device adjusts its own transmission power setting based on the stored indication of transmission power, or estimated path loss.

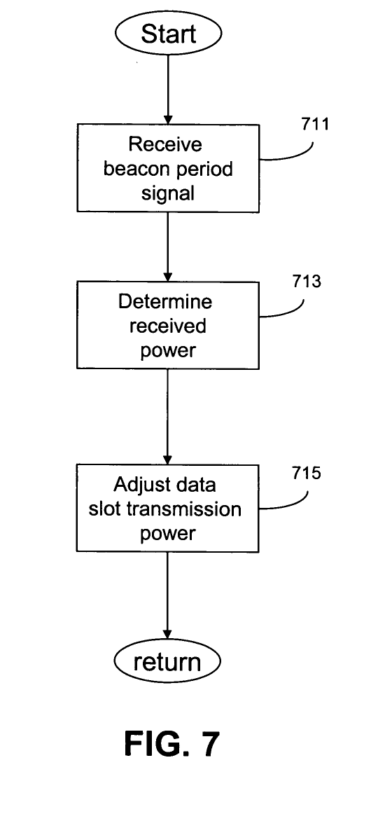

In some embodiments a device performs a process in accordance with the flow diagram of FIG. 7. In block 711 a beacon period signal is received. In some embodiments multiple beacon period signals are received from a plurality of other transmitters, and the device performs the process of FIG. 7 for each beacon period signal received. In block 713 the process determines an indication of transmission power for the received signal. In some embodiments the indication is determined using RSSI circuitry, or VGA settings, and known transmission power of the transmitter. In other embodiments the indication is determined using an estimate of received signal strength and an indication of transmit power included as part of the received beacon period signal. In block 715 the device adjusts its own transmit power based on the indication of transmission power for the received signal and the indication of received signal strength. The adjustment of transmit power is calculated to provide a receiving device a signal of sufficient strength to receive signals without unduly interfering with communication of other devices.

An alternative way of estimating the signal-to-noise (SNR) ratio (besides using the RSSI/AGC mechanism provided by the RF circuitry) is to exploit the statistical properties of the received signal. A hypothesis on both the transmitted signal (modulation, e.g. BPSK) and the underlying noise distribution (e.g. Gaussian) allows estimation of SNR through maximum-likelihood parameter estimation, or sub-optimal but lower complexity heuristic methods. See, for example, T. A. Summers and S. G. Wilson, “SNR Mismatch and Online Estimation in Turbo-Decoding,” IEEE Trans. Commun., vol. 46, no. 4, pp 421-423, April 1998; A. Ramesh, A. Chokalingam, and L. B. Milstein, “SNR Estimation in Generalized Fading Channels and its Application to Turbo Decoding,” Proc. IEEE MILCOM 01, vol. 2, pp. 1141-1145, October 2001; and M. C. Reed and J. Asenstofer, “A Novel Variance Estimator for Turbo-Code Decoding,” in Proc. ICT'97, Melbourne, Australia, April 1997, pp. 173-178, all of which are incorporated by reference herein.

In addition, a multi user wireless link can be described as:
y=h₁(x₁)+h₂(x₂)+ . . . +hₙ(xₙ)+n (2)

Here, xᵢ is the input from user i, and hᵢ is the associated channel. Typically removal of unwanted interference (e.g. i>=2) is advantageous.

During the beaconing period, users may learn each channel hᵢ, since these transmissions contain information from a single source. In a wireless network with multiple beacon groups that may interfere, in some embodiments, members of one beacon group monitor the beacon period of another interfering beacon group so that channel and schedule information may be attained. With this information, inputs x from other users are determined, and then subtracted from the output, so that only one desired input is left.

Accordingly, in some embodiments a receiver performs a process in accordance with the flow diagram of FIG. 8. In block 811 the receiver monitors beacon period signals. In block 813 the receiver determines signals transmitted by interfering transmitters. In block 815 the receiver subtracts or nulls transmissions, such as data period transmissions, from the interfering transmitters. The process thereafter returns.

As described in an earlier section, a channel estimate can be made by monitoring the beaconing period. In time-multiplexed systems, the same channel (or sequence of channels) may be used by both nodes in a transmission pair. In this case, channel reciprocity may be assumed. For example, Node A measures the SNR or other channel quality parameters during beacon transmission by Node B. When Node A transmits to Node B during a data slot, the maximum possible transmission rate may be estimated in whole or in part using the information, such as a channel quality parameter, collected during the beacon period.

Accordingly, the invention provides for wireless device adjustment using signaling period information. Although the invention has been described with respect to certain embodiments, it should be recognized that the invention includes the claims supported by this disclosure and insubstantial variations thereof.

What is claimed is:

1. A method of adjusting operation of a wireless communication device operating in a scheduling-based transmission network, comprising:
receiving a signal from another device during a scheduling period;
determining an aspect of the received signal; and
adjusting operation of the device during a data transmission period based on the aspect of the received signal.

2. The method of claim 1 wherein determining an aspect of the received signal comprises performing channel estimation using the received signal.

3. The method of claim 2 wherein adjusting operation of the device comprises storing an indication of channel quality and using the indication of channel quality in processing signal received during the data transmission period.

4. The method of claim 1 wherein the aspect of the received signal is received signal strength.

5. The method of claim 4 wherein adjusting operation of the device comprises adjusting automatic gain control settings based on the received signal strength.

6. The method of claim 4 wherein adjusting operation of the device comprises adjusting transmitter power based on the received signal strength.

7. The method of claim 1 wherein the aspect of the received signal is received signal quality and adjusting operation of the device comprises selecting a data rate based on the received signal quality.

8. The method of claim 1 wherein the received signal is from an interfering transmitter, the aspect of the received signal is an indication of transmissions from the interfering transmitter during a data transmission period, and adjusting operation of the device comprises reducing effects of transmissions from the interfering transmitter.

9. A method for use by a wireless communication device to initialize channel estimates for data transmission periods in networks using scheduling-based access protocols; comprising:
receiving a signal during a beacon period from another device;
estimating a channel quality of a communication channel between the other device and the wireless communication device using the signal received during the beacon period;
storing an indication of the estimate of the channel quality of the communication channel between the other device and the wireless communication device;
receiving a preamble signal during a data transmission period from the other device;
processing the preamble signal using the indication of the estimate of channel quality of the communication channel between the other device and the wireless communication device.

10. The method of claim 9 wherein the beacon period is followed in time by the data transmission period.

11. The method of claim 10 wherein the beacon period and the data transmission period comprise a superframe.

12. The method of claim 9 wherein processing the preamble signal comprises estimating the channel quality.

13. The method of claim 9 further comprising:
receiving a further signal during the beacon period from a further device;
estimating a channel quality of a communication channel between the further device and the wireless communication device using the further signal received during the beacon period;
storing an indication of the estimate of the channel quality of the communication channel between the further device and the wireless communication device;
receiving a preamble signal during a data transmission period from the further device;
processing the preamble signal using the indication of the estimate of channel quality of the communication channel between the further device and the wireless communication device.

14. A method for use by a wireless communication device to determine a transmission rate for data transmitted by the wireless communication device, comprising:
receiving a signal during a signaling period from another device;
estimating a channel quality of a communication channel between the other device and the wireless communication device using the signal received during the signaling period;
determining a transmission rate for data transmission from the wireless communication device to the other device during a data transmission period using the estimate of channel quality.

15. The method of claim 14 wherein the estimate of channel comprises a signal-to-noise ratio (SNR).
